(19) United States
(12) Patent Application Publication
(10) Pub. No.: US 2013/0160745 A1
(43) Pub. Date: Jun. 27, 2013

(54) FUEL SUPPLY SYSTEM AND A VEHICLE

(71) Applicant: HONDA MOTOR CO., LTD., Tokyo (JP)

(72) Inventors: Masayoshi KAWAGUCHI, SAITAMA (JP); Hirotsugu KUDO, SAITAMA (JP)

(73) Assignee: HONDA MOTOR CO., LTD., TOKYO (JP)

(21) Appl. No.: 13/726,761

(22) Filed: Dec. 26, 2012

(30) Foreign Application Priority Data
Dec. 27, 2011 (JP) 2011-287039
Feb. 20, 2012 (JP) 2012-034567

(51) Int. Cl. F02D 19/06

(52) U.S. Cl. CPC F02D 19/0663
USPC 123/515

(57) ABSTRACT

A raw fuel tank 310 is arranged in a lower space of a front floor panel 111. A part of or all of other component parts of a fuel supply system 3 are accumulated on the rear floor panel 112 and arranged. All of a separator 320, all of a vacuum pump 336 and all of a canister 350 are each hidden by a first fuel tank 340 with respect to an upper stream side of an air path. The first fuel tank 340 is arranged so as to function as a windbreak member or a shield member at least partially blocking each of the separator 320, the vacuum pump 336 and the canister 350 from air flowing the air path.

### TECHNICAL FIELD

The present invention relates to a fuel supply system for supplying fuel with different octane number selectively or at a specified mixing ratio to an internal combustion engine and a vehicle comprising the fuel supply system.

### BACKGROUND ART

There is proposed a technique to separate a raw fuel to a high-octane number fuel and a low-octane number fuel, and to supply the separated fuel to an internal combustion engine (refer to Japanese Patent Laid-open Publication No. 2009-144720).

There is also proposed to arrange component parts such as a fuel separator or the like of a fuel supply system in a vehicle at an appropriate manner from a view point of cooling thereof or the like. For example, there is proposed an arrangement in which a fuel heater, a fuel separator, and a heat exchanging device are arranged in order from a front of a vehicle (refer to Japanese Patent Laid-open Publication No. 2010-013948). Moreover, there is proposed an arrangement in which a fuel cooler, a fuel separator, and a fuel heater are integrated adjacent to a fuel tank, and are arranged in order form a front of a vehicle (refer to Japanese Patent Laid-open Publication No. 2011-208541).

### DISCLOSURE OF THE INVENTION

### Problems to be Solved by the Invention

However, from a view point of temperature dependency of functions of each element of a fuel supply system such as a tank or the like for storing high-octane number fuel, or from a view point of effective utilization of an inner space of a vehicle, there is a room for improvement in an arrangement manner thereof in the vehicle.

In this regard, the present invention aims to provide a fuel supply system in which each element is arranged in an appropriate manner in a vehicle from a view point of temperature dependency of function of each element of the fuel supply system, and to provide a vehicle in which the arrangement manner of each element of the fuel supply system of the vehicle is further improved from a view point of effective utilization of an inner space of the vehicle.

### Means for Solving the Problem

The present invention relates to a system mounted in a vehicle and configured to supply a first fuel which is separated from a raw fuel and containing more high-octane number component than the raw fuel, and the raw fuel or a second fuel which is separated from the raw fuel and containing more low-octane number component than the raw fuel, selectively or by a specified mixing ratio to an internal combustion engine simultaneously, and the vehicle.

The fuel supply system according to the present invention comprises: a separator which is sectioned to a high pressure chamber and a low pressure chamber via a separation membrane, and configured to separate a raw fuel into the first fuel and the second fuel by the separation membrane in a state the low pressure chamber is maintained in a lower pressure than the high pressure chamber, and then to collect the first fuel from the low pressure chamber side and to collect the second fuel from the high pressure chamber side; a condenser which is connected to the low pressure chamber of the separator; a first fuel tank connected to the condenser and configured to store the first fuel; a vacuum pump configured to depress an inner portion of the condenser; wherein the separator and the first fuel tank are accumulated and are configured to be arranged in an air path of the vehicle so that a part of or a total of the separator is hidden by the first fuel tank with respect to an upper stream side of the air path.

According to the fuel supply system of the present invention, the first fuel tank is arranged so as to function as a windbreak member or a shield member at least partially blocking the separator from air flowing in the air path. By this, a heat quantity lost from the separator by a heat exchange with the air flowing in the air path or a temperature of the separator, is adjusted or maintained in an appropriate range from a view point of controlling a fuel separation performance by the separator.

On the other hand, a cooling efficiency of the first fuel tank is maintained or enhanced by the heat exchange between the air and the first fuel tank functioning as the windbreak member as described above. Therefore, a temperature of the first fuel and an inner atmospheric pressure according to the temperature are adjusted or maintained in an appropriate range from a view point of effective utilization or the like of the first fuel (high-octane number fuel) in a gas phase state or the high-octane number component.

Elements of the fuel supply system is “accumulated” means that the elements are adjacent as a lump, or integrally combined, installed or assembled. The elements to be accumulated may be in contact mutually or may be spaced from each other via a void (an air layer) or a heat insulating layer or the like. The elements of the fuel supply system is “configured to” be arranged in a specific manner means that it is designed to be suitable for being equipped in a vehicle in such manner.

In the fuel supply system of the present invention, it is preferable that the separator, the vacuum pump, and the first fuel tank are accumulated and are configured to be arranged in the air path so that a part of or a total of the vacuum pump is hidden by the first fuel tank with respect to the upper stream side of the air path.

According to the fuel supply system of this configuration, the first fuel tank is arranged so as to function as a windbreak member at least partially blocking the vacuum pump from the air flowing in the air path. By this, a heat quantity lost from the vacuum pump by a heat exchange with the air flowing in the air path or a temperature of the vacuum pump, is adjusted or maintained in an appropriate range from a view point of controlling a suction performance of the vacuum pump or a decompressing performance of the condenser.

In the fuel supply system according to the present invention, it is preferably that the vacuum pump is configured to be arranged at a side of the separator.

According to the fuel supply system of this configuration, the vacuum pump is arranged so as to function as a windbreak member at least partially blocking the separator from air flowing so as to come around to a downstream side of the first fuel tank. By this, temperature of each of the separator and the vacuum pump is adjusted or maintained in an appropriate range from a view point of controlling each of the fuel separation performance of the separator and the suction performance of the vacuum pump.

In the fuel supply system of the present invention, it is preferable that the separator, the condenser, and the first fuel tank are accumulated and are configured to be arranged in the air path so that a part of or a total of the condenser is exposed with respect to the upper stream side of the air path.

According to the fuel supply system of this configuration, the condenser is arranged so as to efficiently exchange heat between the air flowing in the air path. By this, temperature of the condenser is adjusted or maintained in an appropriate range from a view point of controlling a fuel condensing performance by the condenser.

In the fuel supply system according to the present invention, it is preferably that the condenser is configured to be arranged at a side of the separator.

According to the fuel supply system of this configuration, the condenser is arranged so as to function as a windbreak member at least partially blocking the separator from the air flowing so as to come around to the downstream side of the first fuel tank. By this, temperature of each of the separator and the condenser is adjusted or maintained in an appropriate range from a view point of controlling each of the fuel separation performance of the separator and the fuel condensing performance of the condenser.

It is preferable that the fuel supply system of the present invention, further comprises a cooler configured to cool the second fuel collected from the separator, wherein the separator, the cooler, and the first fuel tank are accumulated and are configured to be arranged in the air path so that a part of or a total of the cooler is exposed with respect to the upper stream side of the air path.

According to the fuel supply system of this configuration, the cooler is arranged so as to efficiently exchange heat between the air flowing in the air path. By this, temperature of the cooler is adjusted or maintained in an appropriate range from a view point of controlling a cooling performance of the second fuel by the cooler.

It is preferable that the fuel supply system of the present invention, further comprises a canister configured to occlude the high-octane number component occurred from the first fuel or the raw fuel, wherein the separator, the canister, and the first fuel tank are accumulated and are configured to be arranged in the air path so that a part of or a total of the canister is hidden by the first fuel tank observed form the upper stream side of the air path.

According to the fuel supply system of this configuration, the first fuel tank is arranged so as to function as a windbreak member at least partially blocking the canister from the air flowing in the air path. By this, a heat quantity lost from the canister by the heat exchange with the air flowing in the air path or a temperature of the separator, is adjusted or maintained in an appropriate range from a view point of controlling a occlusion performance of the high-octane number component or the like by the canister.

In the fuel supply system according to the present invention, it is preferably that the canister is configured to be arranged at a side of the separator.

According to the fuel supply system of this configuration, the canister is arranged so as to function as a windbreak member at least partially blocking the separator from air flowing so as to come around to the downstream side of the first fuel tank. By this, temperature of each of the separator and the canister is adjusted or maintained in an appropriate range from a view point of controlling each of the fuel separation performance of the separator and the occlusion performance of the high-octane number component or the like by the canister.

It is preferable that in the fuel supply system according to the present invention further comprises a raw fuel tank configured to store the raw fuel, wherein among component parts of the fuel supply system, the raw fuel tank is configured to be arranged in a lower space of a front floor panel of the vehicle, and a part of or all of other component parts are accumulated and configured to be arranged in a rear floor panel.

According to the fuel supply system of this configuration, the space existing under the front floor panel is efficiently utilized as an arrangement space of the raw fuel tank, and in addition, a rear space of the raw fuel tank is efficiently utilized as an arrangement space for other component parts of the fuel supply system. By this, each component parts of the fuel supply system can be installed in the vehicle while eliminating or restraining to minimum necessary the small-sizing of the cabin space and the necessity to change the arrangement including the height change of the seat according thereto (ensuring a largeness of the cabin space).

Moreover, by installing the rear floor panel to the vehicle body frame in a state in which the component parts of the fuel supply system other than the raw fuel tank are accumulated and arranged or equipped, the work of installation of the component parts to the vehicle body is streamlined.

It is preferable that in the fuel supply system according to the present invention, at least one component part excluding the raw fuel tank among the component parts of the fuel supply system is configured to be at least partially accommodated in a lower level portion which is formed in the rear floor panel and locally downwardly lowered or hollowed.

According to the fuel supply system of this configuration, it is able to lower the upper end position of the component part of the fuel supply system which is arranged so that at least a part of it is accommodated in the lower level portion formed in the rear floor panel, compared to the original position.

By this, each component parts of the fuel supply system can be installed in the vehicle while eliminating or restraining to minimum necessary the necessity to reduce the volume of the component part (ensuring a dimension for the volume of the component part). Moreover, each component parts of the fuel supply system can be installed in the vehicle while eliminating or restraining to minimum necessary the necessity of small-sizing of the cabin space or the luggage space above the rear floor panel (ensuring a largeness of the space).

It is preferable that in the fuel supply system according to the present invention, the first fuel tank, as the at least one component part, is configured to be at least partially accommodated in the lower level portion.

According to the fuel supply system of this configuration, by accommodating a part of the first fuel tank in the lower level portion, it is able to install each component part of the fuel supply system in the vehicle while ensuring a largeness of the luggage space or the like in addition to ensuring a dimension for the volume of the first fuel tank. Therefore, this is a significant configuration especially in a case where the separation amount of the first fuel is large due to the content of the high-octane number component in the raw fuel being large.

Moreover, the cooling efficiency of the first fuel tank is improved by the heat exchange of the first fuel tank and the air flowing on the lower side of the rear floor panel. Therefore, the temperature of the first fuel or an inner atmospheric pressure according to the temperature is adjusted or maintained in an appropriate range from a view point of effective utilization of the first fuel (high-octane number fuel) in a gas phase state or the high-octane number component.

It is preferable that in the fuel supply system according to the present invention, the raw fuel tank is configured to be at least partially accommodated in a floor tunnel.

According to the fuel supply system of this configuration, it is able to install each component part of the fuel supply system in the vehicle while ensuring a largeness of the cabin space in addition to ensuring a dimension for the volume of the raw fuel tank.

### BRIEF DESCRIPTION OF THE DRAWINGS

FIG. 1 is an explanatory side view of a vehicle as a first embodiment of the present invention;

FIG. 2 is an explanatory top view of the vehicle as the first embodiment of the present invention;

FIG. 3 is an explanatory view regarding a first arrangement manner of component parts of a fuel supply system;

FIG. 4 is an explanatory view regarding an arrangement manner of a raw fuel tank;

FIG. 5 is an explanatory side view of a vehicle as a second embodiment of the present invention;

FIG. 6 is an explanatory top view of the vehicle as the second embodiment of the present invention;

FIG. 7 is an explanatory view regarding a second arrangement manner of component parts of the fuel supply system;

FIG. 8 is an explanatory block diagram of the fuel supply system of the first embodiment of the present invention;

FIG. 9A is an explanatory view regarding a negative pressure control process (first embodiment)—in which a condenser is depressurized by the operation of a vacuum pump in a first state in which a fourth opening-closing mechanism is opened while a first opening-closing mechanism, a second opening-closing mechanism, and a third opening-closing mechanism are closed;

FIG. 9B is an explanatory view regarding a negative pressure control process (first embodiment)—showing a second state, in which separation of a first fuel and a second fuel y the separator is started, and the first fuel in a gas phase state is supplied to the condenser from the separator;

FIG. 9C is an explanatory view regarding a negative pressure control process (first embodiment)—showing a third state, in which the first opening-closing mechanism and the fourth opening-closing mechanism are closed while the second opening-closing mechanism and the third opening-closing mechanism are opened;

FIG. 9D is an explanatory view regarding a negative pressure control process (first embodiment)—showing a fourth state, in which a fifth opening-closing mechanism is opened;

FIG. 10 is an explanatory block diagram of the fuel supply system of the second embodiment of the present invention;

FIG. 11A is an explanatory view regarding a negative pressure control process (second embodiment)—in which both of the second opening-closing mechanism and the third opening-closing mechanism are closed, the first state is realized again and the operation of the vacuum pump is started;

FIG. 11B is an explanatory view regarding a negative pressure control process (second embodiment)—in which the operation of the vacuum pump is stopped and the first opening-closing mechanism is opened; and

FIG. 11C is an explanatory view regarding a negative pressure control process (second embodiment)—in which the first opening-closing mechanism is closed, while the second opening-closing mechanism and the third opening-closing mechanism are opened.

### MODE FOR CARRYING OUT THE INVENTION

### Configuration of a Vehicle (First Embodiment)

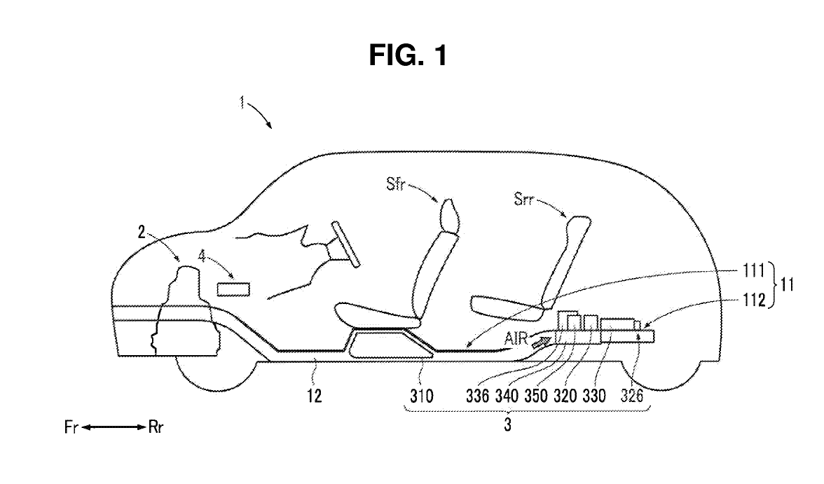

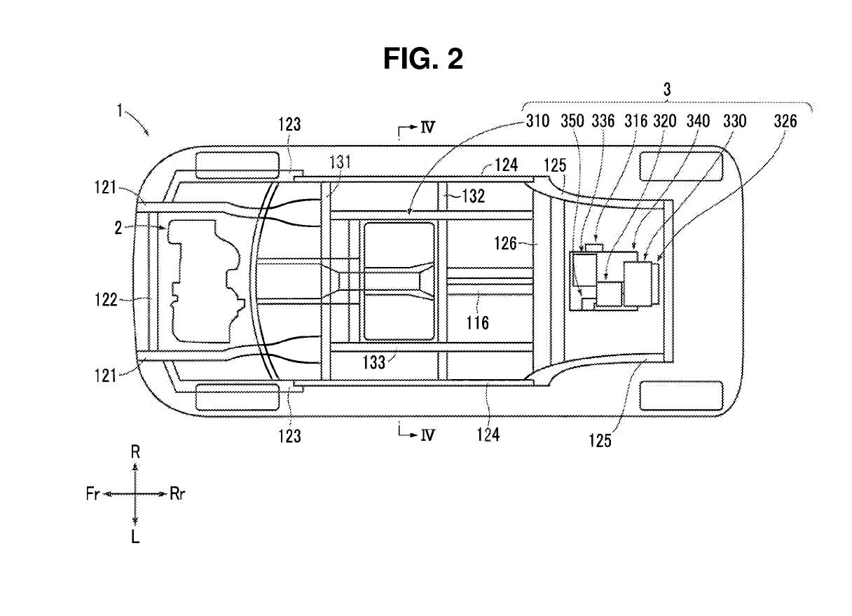

A vehicle 1 as a first embodiment of the present invention shown in FIG. 1 and FIG. 2 comprises an internal combustion engine 2, a fuel supply system 3, and an ECU (electronic control unit (controller)) 4. Each of a front, back, right, and left of the vehicle 1 is indicated by symbols with arrows Fr, Rr, R, and L, respectively.

The vehicle 1 is a 2-box type vehicle having an engine room and a cabin space accessible from a tailgate. There is no partition between the cabin space and a luggage space (trunk room). The cabin space is demarcated by, for example, front and rear vehicle axle. A front seat Sfr (driver's seat and front passenger's seat) and a back seat Srr for the passengers are arranged in order from the front in the cabin space. A space behind the back seat Srr among the cabin space corresponds to the luggage space.

The engine 2 arranged in an engine room is installed in a front portion of a vehicle body frame (vehicle body) 12.

A floor panel 11 is paneled over the vehicle body frame 12. The floor panel 11 is composed of a front floor panel 111 and a rear floor panel 112, which are arranged in order form the front side. As will be described later, a raw fuel tank 310 which is one of the component parts of the fuel supply system 3 is arranged in the space under the front floor panel 111. Moreover, at least a part of other component parts of the fuel supply system 3 are accumulated on the rear floor panel 112 and installed.

The vehicle body frame 12 comprises as its elements, a pair of front side frames 121, a front cross member 122, a pair of upper members 123, a pair of side sills 124, a pair of rear side frames 125, a middle cross member 126, and a rear cross member 127.

The front side frames 121 are extendedly provided in the front-back direction at both of right and left sides of the front portion of the vehicle 1. The front cross member 122 is bridged over between front portions of the pair of front side frames 121. The upper members 123 are arranged at outer sides in a vehicle width direction of the pair of front side frames 121 and at obliquely upward portions thereof, and are extendedly provided in the vehicle body front-back direction. The side sills 124 are joined to back portions of the upper members 123. The rear side frames 125 are extendedly provided backward from back portions of the side sills 124. The middle cross member 126 is bridged over between back portions of the pair of side sills 124. The rear cross member 127 is bridged over between back portions of the pair of rear side frames 125.

Moreover, in order to reinforce the floor panel 11, the vehicle body frame 12 comprises four under floor reinforcement members (floor frames) which are arranged in approximately double cross shape or hash mark shape in planar view approximately at a center portion of the vehicle body. A front portion floor frame 131, a rear portion floor frame 132, a left side portion floor frame 133 and a right side portion floor frame 134 correspond to the four under floor reinforcement members. Each of the front floor portion frame 131 and the rear portion floor frame 132 is bridged over between right and left pair of side sills 124. Each of the left side portion floor frame 133 and right side portion floor frame 134 is bridged over between back portions of a pair of front side frames 121 and the middle cross member 126.

The raw fuel tank 310 is arranged in a space where the front, back, right and left are surrounded by the four under floor reinforcement members 131 to 134. By reinforcing the portion supporting the raw fuel tank 310 with relatively much weight, the weight increase of the whole floor is restrained as well as the rigidity of the floor panel 11 is ensured.

A floor tunnel 116 is formed in order to enhance the rigidity of the front floor panel 111. The floor tunnel 116 is a tunnel extending in the front-back direction at a center portion in the lateral direction of the cabin space from a dashboard lower 135 to the middle cross member 126. Therefore, the floor tunnel 116 passes above the raw fuel tank 310.

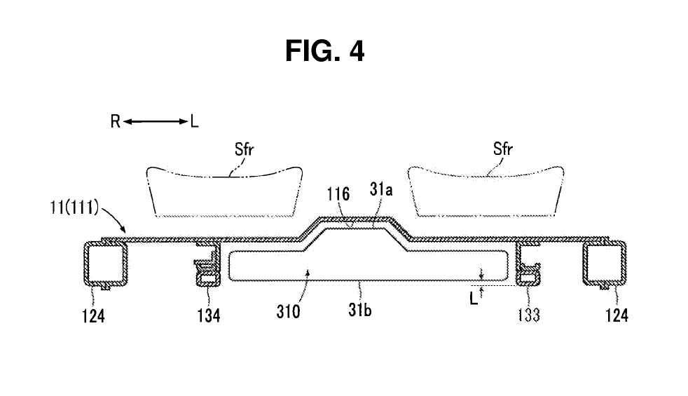

As is shown in FIG. 4, the floor panel 11 (the front floor panel 111) is paneled between the right and left pair of side sills 124. The floor tunnel 116 passes between the right and left front seats Sfr. The raw fuel tank 310 is arranged in the lower space of the front floor panel 111, and at least a part of (center upper portion) the raw fuel tank 310 is expanded out upward, and the upper expanded portion 31a is arranged so as to be accommodated in the floor tunnel 116. In the present embodiment, when the vehicle is seen from above, the raw fuel tank 310 is arranged so as to overlap with the front seat Sfr. Alternatively, the raw fuel tank 31 may be displaced to a position which does not overlap with the front seat Sfr.

The upper expanded portion 31a of the raw fuel tank 310 may be abbreviated or the amount of upper expansion may be reduced from a view point of enlarging a surface area of a void of the floor tunnel 116 constituting an air path, and further to ensure amount of air flow.

A lower end surface of at least one of the four under floor reinforcement members 131 to 134 attached to the lower surface of the floor panel 11 is positioned lower than a bottom surface 31b of the raw fuel tank 310. Therefore, the raw fuel tank is prevented from contacting the ground. Each of a space between the left side portion floor frame 133 and the side sill 124 of the left side and a space between right side portion floor frame 134 and the side sill 124 of the right side is efficiently used as an arrangement space for an exhaust pipe and a fuel pipe or the like.

As is shown in FIG. 2, the rear floor panel 112 is paneled between right and left pair of rear side frames 125. At least a part of the component parts of the fuel supply system 3 excluding the raw fuel tank 310 are accumulated and arranged on the rear floor panel 112. In the present embodiment, at least a separator 320, a condenser 330, a vacuum pump 336, a first fuel tank 340, and a canister 350 are installed to the rear floor panel 112.

The elements of the fuel supply system 3 are accumulated and arranged in the air path by fulfilling a part of, which at least includes condition 1, or all of the following conditions 1 to 8. The air path is configured of arbitrary space which communicates with outside air and generates air flow when the vehicle travels or moves, such as upper spaces of the floor tunnel 116 and the rear floor panel 112 or the like. At least one of a void (an air layer) and a thermal insulating member (thermal insulating layer) intervenes between each element. The thermal insulating layer may be configured by a connecting member among the elements.

(Condition 1) A part of or all of the separator 320 is hidden by the first fuel tank 340 with respect to an upper stream side of the air path.

(Condition 2) A part of or all of the vacuum pump 336 is hidden by the first fuel tank 340 with respect to the upper stream side of the air path.

(Condition 3) The vacuum pump 336 is arranged at the side of the separator.

(Condition 4) A part of or all of the condenser 330 is exposed with respect to the upper stream side of the air path.

(Condition 5) The condenser 330 is arranged at the side of the separator 320.

(Condition 6) A part of or all of a heat radiator (cooler) 326 is exposed with respect to the upper stream side of the air path.

(Condition 7) A part of or all of the canister 350 is hidden by first fuel tank 340 with respect to the upper stream side of the air path.

(Condition 8) The canister 350 is arranged at the side of the separator 320.

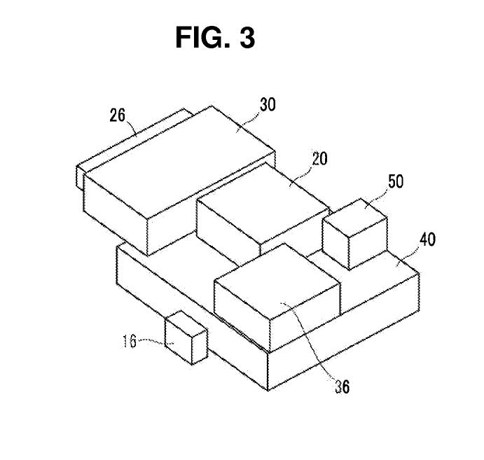

For example, as is shown in FIG. 3, a heater 316, the separator 320, the heat radiator 326, the condenser 330, the vacuum pump 336, the first fuel tank 340, and the canister 350 are accumulated and arranged in the air path of the vehicle so as to satisfy all of conditions 1 to 8.

An assembly or an accumulated unit composed of the plurality of elements shown in FIG. 3 are, for example, as is shown in FIG. 1 and FIG. 2, arranged in the rear side of the raw fuel tank 310 and in a space communicating with the outside air, specifically in the upper space of the rear floor panel 112. The internal combustion engine 2 and the controller 4 are installed in the front portion of the vehicle. In such case, as is shown in FIG. 1, the assembly as a whole is exposed with respect to the air flowing from the upper stream side of the air path (refer to the arrow) including the space under the raw fuel tank 310. The direction of the air flow corresponds to a line of sight in a case where observed from the upper stream side of the air path.

Here, conditions 1, 2, and 7 are satisfied since all of the separator 320, all of the vacuum pump 336, and all of the canister 350 are each hidden by the first fuel tank 340 with respect to the upper stream side of the air path. That is, the first fuel tank 340 is arranged so as to function as a windbreak member or a shield member at least partially blocking each of the separator 320, the vacuum pump 336, and the canister 350 from the air flowing in the air path (refer to FIG. 1 to FIG. 3).

By this, a heat quantity or a temperature lost by the heat exchange with the air flowing in the air path is adjusted or maintained in an appropriate range from a view point of controlling each of a fuel separation performance by the separator 320, a decompressing performance of the condenser 330 by the vacuum pump 336, and an occlusion performance of the high-octane number component or the like by the canister 350.

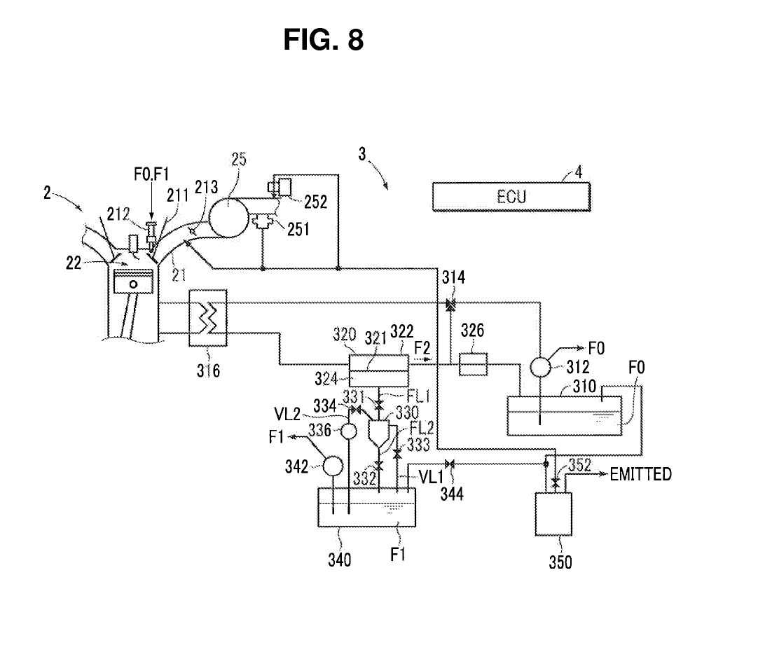

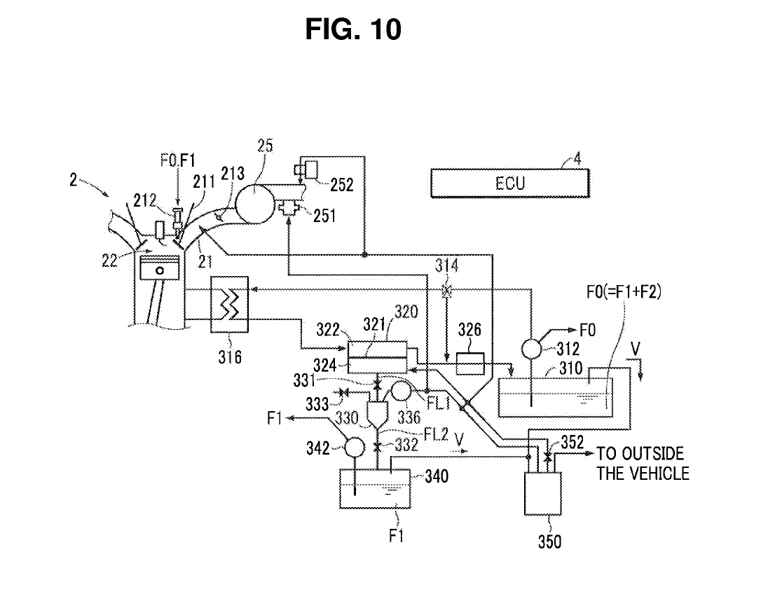

On the other hand, a cooling efficiency of the first fuel tank 340 is maintained or enhanced by the heat exchange between the air and the first fuel tank 340 functioning as the windbreak member as described above. Therefore, a supply amount of evaporation fuel V from the first fuel tank 340 to the canister 350 (refer to FIG. 8 and FIG. 10) can be controlled to a range which can be occluded by the canister 350. That is, a temperature of the first fuel F₁ and an inner atmospheric pressure of the first fuel tank 340 according to the temperature are adjusted or maintained in an appropriate range from a view point of effective utilization or the like of the first fuel F₁ in a gas phase state (high-octane number fuel) or the high-octane number component.

Moreover, conditions 3, 5, and 8 are satisfied since each of the condenser 330, the vacuum pump 336, and the canister 350 is arranged so as to surround the separator 320 at the side thereof. That is, the vacuum pump 336, the condenser 330, and the canister 350 are arranged so as to function as windbreak members at least partially blocking the separator 320 from air flowing so as to come around to a downstream side of the first fuel tank 340. By this, temperature of each element such as the separator 320 or the like is adjusted or maintained in an appropriate range from a view point of performance control of the separator 320 and the vacuum pump 336 or the like arranged so as to surround the separator 320.

Moreover, conditions 4 and 6 are satisfied since all of the heat radiator 326 and a part of the condenser 330 are exposed with respect to the upper stream side of the air path. That is, each of the condenser 330 and the heat radiator 326 is arranged so as to efficiently exchange heat between the air flowing in the air path. By this, each of the temperature of the condenser 330 and the heat radiator 326 is adjusted or maintained in an appropriate range from a view point of controlling a fuel condensing performance by the condenser 330 and a cooling performance of the second fuel F₂ by the heat radiator 326.

Also all of the heater 316 is exposed with respect to the upper stream side of the air path. Although each element is simplified and shown by an approximately rectangular parallelepiped shape, at least one of a shape, a size, and an aspect ratio thereof may be changed. One of or both of a position and a posture of each element when installed in the vehicle (a relative position and posture with respect to the air path) may be changed under the condition that at least condition 1 is satisfied.

Only a part of the elements including at least the separator 320 and the first fuel tank 340, among the heater 316, the separator 320, the heat radiator 326, the condenser 330, the vacuum pump 336, the first fuel tank 340, and the canister 350, may be accumulated and arranged in the air path.

If a part of or all of the elements are configured to be installed in the vehicle in an assembled state beforehand, the manufacturing cost of the vehicle comprising the fuel supply system can be reduced. The separator 320 can be configured to be detachable independently from a view point of facilitating maintenance or the like.

A lower level portion which is locally downwardly lowered or hollowed is formed in the rear floor panel 112, and at least one component part of the fuel supply system 3 excluding the raw fuel tank 310 may be installed to the rear floor panel 112 so as to be partially or totally accommodated in the lower level portion 112b. For example, at least a part of the first fuel tank 340 may be arranged so as to be accommodated in the lower level portion.

### Configuration of a Vehicle (Second Embodiment)

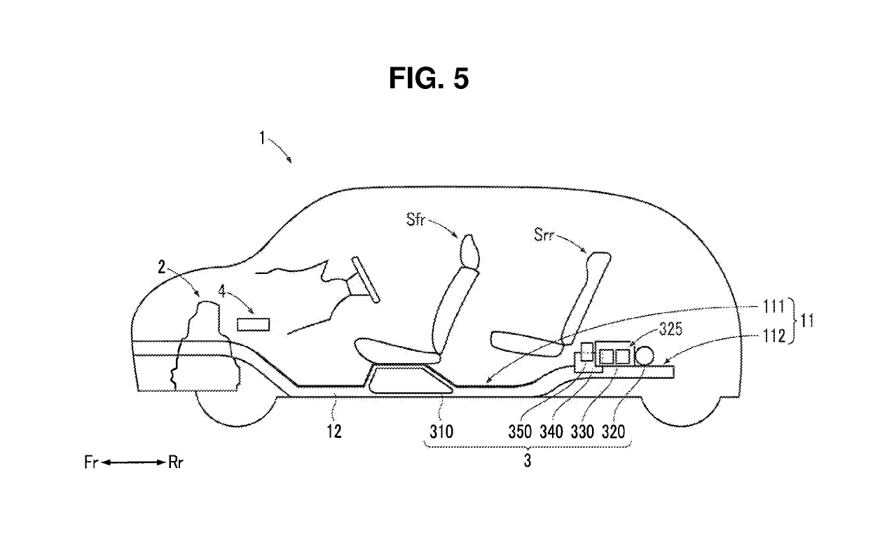

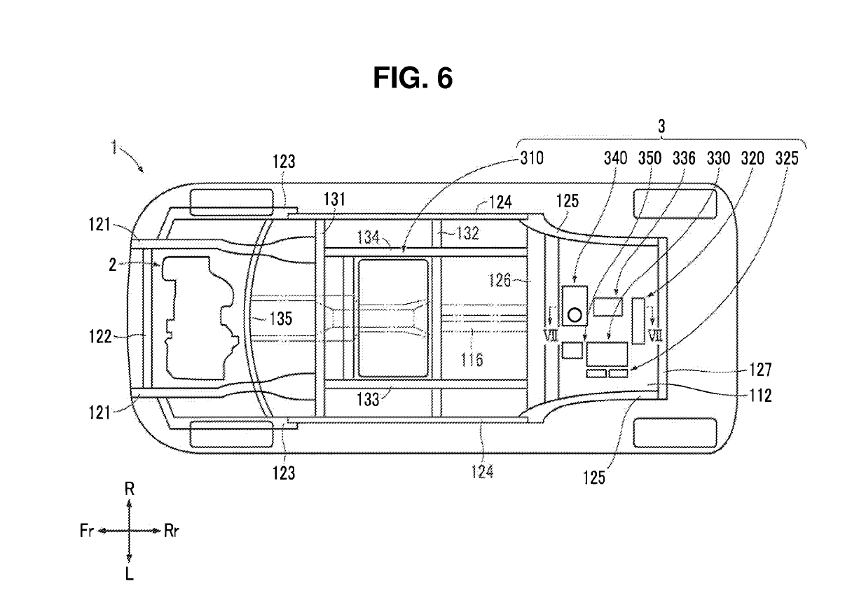

A vehicle 1 as a second embodiment of the present invention shown in FIG. 5 and FIG. 6 has approximately the same features of the vehicle 1 (refer to FIG. 1 and FIG. 2) as the first embodiment of the present invention, except for the arrangement manner of the component parts of the fuel supply system 3 except the raw fuel tank 310. Therefore, the same reference numerals will be used for the same features and the explanation thereof is abbreviated.

Among the component parts of the fuel supply system 3, at least a separator 320, a condenser 330, a vacuum pump 336, a first fuel tank 340, and a canister 350 are installed to a rear floor panel 112.

The first fuel tank 340, the vacuum pump 36, and the separator 320 are arranged in order from the front at approximately a center portion in the lateral direction of the rear floor panel 112. The canister 350 and the condenser 330 are arranged in order form the front at a left side portion of the rear floor panel 112. A fan 325 for cooling a cooler 326 is arranged at the side of the condenser 330.

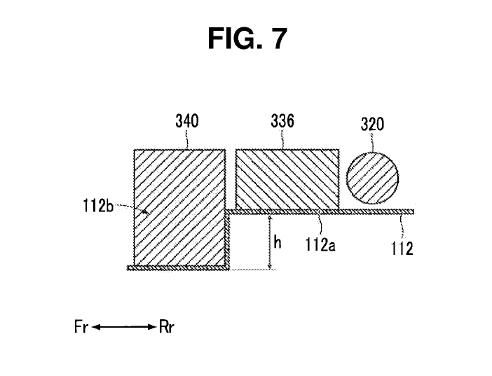

As is shown in FIG. 7, a lower level portion 112b which is locally lowered or hollowed is formed in the rear floor panel 112. That is, the lower level portion 112b is lower than an upper level portion 112a in the periphery thereof. At least one of the component parts of the fuel supply system 3 excluding the raw fuel tank 310 is installed to the rear floor panel 112 so as to be accommodated partially or totally in the lower level portion 112b. In the present embodiment, at least a part of the first fuel tank 340 (for example, an lower expanded portion which expands downward) is arranged so as to the accommodated in the lower level portion 112b.

The raw fuel tank 310 is arranged so that at least the upper expanded portion 31a which is a part of the raw fuel tank is accommodated in a floor tunnel 116 (refer to FIG. 4). Therefore, it is able to ensure a largeness of the cabin space in addition to ensure a dimension for the volume of the raw fuel tank 310.

Moreover, in addition to a space existing under the front floor panel 111 is efficiently utilized as an arrangement space of the raw fuel tank 310, a rear space of the raw fuel tank 310 is efficiently utilized as an arrangement space for other component parts of the fuel supply system 3 (refer to FIG. 1, FIG. 2, FIG. 5, and FIG. 6). By this, each component parts of the fuel supply system 3 can be installed in the vehicle 1 while eliminating or restraining to minimum necessary the small sizing of the cabin space and the necessity to change the arrangement including the change of height of the seat Sfr, Srr according thereto (ensuring a largeness of the cabin space).

Moreover, by installing the rear floor panel 112 to the vehicle body frame 12 in a state in which the component parts of the fuel supply system 3 other than the raw fuel tank 310 are accumulated and arranged or equipped, the work of installation of the component parts to the vehicle body is streamlined.

Furthermore, it is able to lower the upper end position of the component part of the fuel supply system 3 which is arranged so that at least a part of it is accommodated in the lower level portion 112b formed in the rear floor panel 112, compared to the original position. By this, each component part of the fuel supply system can be installed in the vehicle while eliminating or restraining to minimum necessary the necessity to reduce the volume of the component part (ensuring a dimension for the volume of the component part). Moreover, each component part of the fuel supply system can be installed in the vehicle while eliminating or restraining to minimum necessary the necessity of small-sizing of the cabin space or the luggage space above the rear floor panel (ensuring a largeness of the space).

Especially, by accommodating a part of the first fuel tank 340 in the lower level portion 112b, it is able to ensure a dimension for the volume of the first fuel tank 340. Therefore, this is a significant configuration especially in a case where the separation amount of the first fuel F₁ is large due to the content of the high-octane number component in the raw fuel F₀ being large.

Moreover, the cooling efficiency of the first fuel tank 340 is improved by the heat exchange of the first fuel tank 340 and the air flowing in the air path or in the lower side of the rear floor panel 112. Therefore, the temperature of the first fuel F₁ or an inner atmospheric pressure according to the temperature is adjusted or maintained in an appropriate range from a view point of effective utilization of the first fuel F₁ (high-octane number fuel) in a gas phase state or the high-octane number component.

### Configuration of a Fuel Supply System (First Embodiment)

A fuel supply system 3 as the first embodiment of the present invention shown in FIG. 8 comprises a raw fuel tank (second fuel tank) 310, a separator 320, a condenser 330, a first fuel tank 340, a canister 350, and a controller 4 composed of an ECU (electronic control unit).

Normal or commercial gasoline provided through a fuel filler is stored as raw fuel F₀ in the raw fuel tank 310. The raw fuel F₀ stored in the raw fuel tank 310 is supplied to the internal combustion engine 2 after its pressure is raised to a designated atmospheric pressure by a high pressure supply pump 12. A concentration sensor for measuring a concentration C₂ of high-octane number component of raw fuel F₀ is provided at the raw fuel tank 310. In a case where the high-octane number component is alcohol such as ethanol or the like, the concentration sensor is configured by sensors, for example, recited in Japanese Patent Laid-open Publication No. H05-080014, or Japanese Patent Laid-open Publication No. H06-027073.

Furthermore, the raw fuel F₀ is sent to the separator 320 after its pressure is raised to the designated atmospheric pressure by the high pressure supply pump 12, and then being heated by a heater 316. In a case where the raw fuel tank 310 and the heater 316 are intercepted by a three-way valve 314, the raw fuel F₀ is returned to the raw fuel tank 310 through a radiator (cooler) 326 without passing through the separator 320. The heater 316 is composed of a heat exchanger which exchanges heat of a coolant water of the internal combustion engine 2 and the raw fuel. As an alternative, or in addition to this, the heater 316 can be configured by an electric heater.

By an evaporation of the raw fuel F₀ stored in the raw fuel tank 310, evaporation fuel V containing hydrocarbon and ethanol is generated. The evaporation fuel V is supplied to the canister 350 from the raw fuel tank 310.

The separator 320 is configured to separate the raw fuel F₀ into a first fuel F₁ and a second fuel F₂ according to penetrative vaporization (PV (pervaporation)). The separator 320 comprises a separation membrane 321 which selectively permeates high-octane number component in the raw fuel (gasoline), and a high pressure chamber 322 and a low pressure chamber 324 sectioned by the separation membrane 321 (not shown in the figures).

The first fuel F₁ is a high-octane number fuel, for example, alcohol such as ethanol or the like, having more content amount of high-octane number component compared to the raw fuel F₀. The second fuel F₂ is a low-octane number fuel having less content amount of high-octane number component compared to the raw fuel F₀.

In particular, raw fuel F₀ in a high temperature and high pressure state is supplied to the high pressure chamber 322 of the separator 320, while by maintaining the low pressure chamber 324 in a negative pressure state, the high-octane number component contained in the raw fuel F₀ permeates the separation membrane 321 and effuses to the low pressure chamber 324. As an amount of high-octane number component in the raw fuel F₀ increases, the octane number of the permeating liquid becomes higher. Therefore, the first fuel F₁ containing more high octane- number component and having a higher octane number compared to the raw fuel F₀ is collected from the low pressure side of the separation membrane 321.

The first fuel F₁ flown out from the separator 320 is stored in the first fuel tank 340. A concentration sensor for measuring the concentration C₁ of the high-octane number component of the first fuel F₁ is provided at the first fuel tank 340.

On the other hand, since the amount of high-octane number component contained in the raw fuel F₀ flowing through the high pressure chamber 322 decreases as it flows to the down stream, the second fuel F₂ containing a small amount of high-octane number component and having a lower octane number compared to the raw fuel F₀ remains in the high pressure chamber 322. The second fuel F₂ flowing out from the separator 320 is supplied to the raw fuel tank 310 after being cooled by the radiator 326.

Furthermore, the operating conditions of the separator 320 such as a temperature of the separation membrane 321, a temperature and a supply amount of the raw fuel F₀, and the atmospheric pressure of the high pressure chamber 322 and the atmospheric pressure (negative pressure) of the low pressure chamber 324, or the like are controlled. By this, the separation speed or the collection amount of the first fuel F₁ and the second fuel F₂ by the separator 320 changes.

For example, the temperature of the separation membrane 321 can be adjusted by controlling the temperature of the raw fuel F₀ supplied to the separator 320 by the heater 316. Furthermore, the atmospheric pressure of the low pressure chamber 324 can be adjusted according to a depressurization of the condenser 330 by an operation of a vacuum pump 336.

The second fuel F₂ may be provided to a second fuel tank (not shown in the figures) different from the raw fuel tank 310, and then stored in the second fuel tank. Moreover, the second fuel F₂ stored in the second fuel tank may be supplied to the internal combustion engine 2 instead of the raw fuel F₀.

The condenser (negative pressure tank) 330 is provided on the way of a collecting path connecting the low pressure chamber 324 of the separator 320 and the first fuel tank 340, and is configured to condense the first fuel F₁. The condenser 330 is composed of, for example, an air cooling type or a water cooling type tank or a reservoir.

The condenser 330 is connected to the intake side of the vacuum pump (negative pressure pump) 336. The inside of the condenser 330 is controlled to a negative pressure state by the operation of the vacuum pump 336, and to be in a low pressure state compared to a vapor pressure of the first fuel F₁. The evaporation fuel V containing alcohol such as ethanol or the like generated by the evaporation of the first fuel F₁ is supplied to the canister 350 or the like by the operation of the vacuum pump 336. The condenser 330 is provided with an atmospheric pressure sensor for measuring the internal atmospheric pressure of the condenser.

In a first collecting path FL1 connecting the separator 320 and the condenser 330, a first opening-closing mechanism 331 is provided for opening and closing this path. The low pressure chamber 324 of the separator 320 and the condenser 330 communicate by opening the first opening-closing mechanism 331. On the other hand, by closing the first opening-closing mechanism 331, the separator 320 and the condenser 330 are intercepted.

In a secondary collecting path FL2 connecting the condenser 330 and the first fuel tank 340, a second opening-closing mechanism 332 is provided for opening and closing this path FL2. The condenser 330 and the first fuel tank 340 communicate by opening the second opening-closing mechanism 332. On the other hand, by closing the second opening-closing mechanism 332, the condenser 330 and the first fuel tank 340 are intercepted.

The condenser 330 and the first fuel tank 340 are connected by a first evaporation fuel path VL1 different from the secondary collecting path FL2, and a third opening-closing mechanism 333 is provided in the first evaporation fuel path VL1. By opening the third opening-closing mechanism 333, the evaporation fuel V filling the first fuel tank 340 is introduced to the condenser 330.

The condenser 330 and the first fuel tank 340 are connected through a second evaporation fuel path VL2 different from the first evaporation fuel path VL1, and a fourth opening-closing mechanism 334 and the vacuum pump 336 are provided in the second evaporation fuel path VL2. By opening the fourth opening-closing mechanism 334 and by operating the vacuum pump 336, the evaporation fuel V is introduced from the condenser 330 to the first fuel F₁ stored in the first fuel tank 340.

The first fuel F₁ separated from the raw fuel F₀ by the separator 320 is stored in the first fuel tank 340. The first fuel F₁ stored in the first fuel tank 340 is supplied to the internal combustion engine 2 after having its pressure raised to a designated atmospheric pressure by a high pressure supply pump 42.

By the evaporation of the first fuel F₁ stored in the first fuel tank 340, evaporation fuel V containing alcohol such as ethanol or the like is generated. The first fuel tank 340 and the canister 350 are connected and a fifth opening-closing mechanism 335 is provided in this connecting path. By opening the fifth opening-closing mechanism 335, the evaporation fuel V is supplied to the canister 350 from the first fuel tank 340 through the connecting path.

The first fuel tank 340 is provided with an atmospheric pressure sensor (not shown in the figures) for measuring the internal atmospheric pressure thereof.

Each of the opening-closing mechanisms 331 to 335 is configured of, for example, a solenoid valve.

The canister 350 is embedded with adsorbent material such as activated carbon or the like, and not only alcohol contained in the evaporation fuel V derived from the raw fuel F₀ but also hydrocarbon are adsorbed by the adsorbent material. By this, the evaporation fuel V can be separated into alcohol and hydrocarbon, and other components such as nitrogen or the like.

The air containing the separated nitrogen or the like is discharged to outside the vehicle from the canister 350. On the other hand, when the internal combustion engine 2 is activated and an intake pipe 21 becomes a negative pressure state, the alcohol and the hydrocarbon adsorbed to the adsorbent material in the canister 350 are supplied to the intake pipe 21 at the downstream side of a throttle valve 213, and further introduced to a combustion chamber 22, and then combusted. In a discharging path connected to the canister 350, a flow amount adjusting valve 352 for adjusting the flow amount of the evaporation fuel V in the discharging path is provided.

It may be configured that the canister 350 is heated by the condensation heat of the first fuel F₁ generated at the condenser 330, and the temperature thereof is maintained within a temperature range which sufficiently exhibit the adsorptive performance of the evaporation fuel V. For example, a flow path of a coolant medium of the condenser 330 may be configured so that the canister 350 is heated by the coolant medium.

The intake pipe 21 connected to the combustion chamber of the internal combustion engine 2 is provided with an intake valve 211, a fuel injection device 212, and a throttle valve 213. By opening the intake valve 211, the intake pipe 21 and the combustion chamber is communicated. On the other hand, by closing the intake valve 211, the intake pipe 21 and the combustion chamber is interrupted. The throttle valve 213 is configured so as to adjust an inhaled air amount of the internal combustion engine 2.

A fuel injection device 212 is arranged between the intake valve 211 and the throttle valve 213 and is configured to inject selectively one of the raw fuel F₀ and the first fuel F₁ to each cylinder of the internal combustion engine 2. The fuel injection device 212 may also be configured to inject simultaneously both of the raw fuel F₀ and the first fuel F₁ at a specified mixing ratio to each cylinder of the internal combustion engine 2. A mixed gas of air inhaled to the intake pipe 21 and the fuel injected from the fuel injection device 212 is introduced to the combustion chamber of each cylinder from the intake pipe 21.

In the case the second fuel tank is provided, the fuel injection device 212 may be configured to inject selectively one of the first fuel F₁ and the second fuel F₂ or inject the both simultaneously at a specified mixing ratio to each cylinder of the internal combustion engine 2.

The intake pipe 21 is provided with a turbocharger 25, a venturi gas mixer 251 and a purge pump 252 at an upstream side of the throttle valve 213. The evaporation fuel V is supplied to the intake pipe 21 from the canister 350 through the purge pump 252 and the turbocharger 25.

The internal combustion engine 2 may be a naturally aspirated engine and not an engine with the turbocharger 25. In such a case, the evaporation fuel V may be supplied to the intake pipe 21 from the canister 350 at the downstream side of the throttle valve 213 through a purge control valve (not shown in the figures).

Moreover, the evaporation fuel V may be directly provided to the intake pipe 21 from the condenser 330 by the venturi gas mixer 251. Furthermore, the evaporation fuel V may be directly supplied to the intake pipe 21 of the internal combustion engine 2 from the first fuel tank 340.

The controller 4 is composed of a programmable computer. The controller 4 is input with output signals of various types of sensors, such as the concentration sensor provided at the raw fuel tank 310, the concentration sensor provided at the first fuel tank 340, and the atmospheric pressure sensor provided at the condenser 330 or the like, for detecting a state of the fuel supply system. The output signals of these sensors and an arithmetic processing results obtained based on the output signals are stored in a storing device configuring the controller 4.

The controller 4 is programmed to perform negative pressure control processing or the like. The controller 4 is programmed to execute arithmetic processing necessary for adjusting operation conditions of the separator 320, adjusting fuel supplied to the internal combustion engine 2, and operation control of each pump and opening-closing or opening degree adjustment of each valve, as well as to execute fuel injection control and ignition timing control of the internal combustion engine 2.

“Programmed” means that the arithmetic processing unit such as a CPU or the like which is a component of the computer is configured to read out the software in addition to necessary information from a memory such as a ROM or RAM or the like, or a record medium, and to execute arithmetic processing with respect to the information according to the software.

### Negative Pressure Control Processing (First Embodiment)

“Negative pressure control processing” is repeatedly executed by the controller 4 according to the steps which will be explained hereinafter.

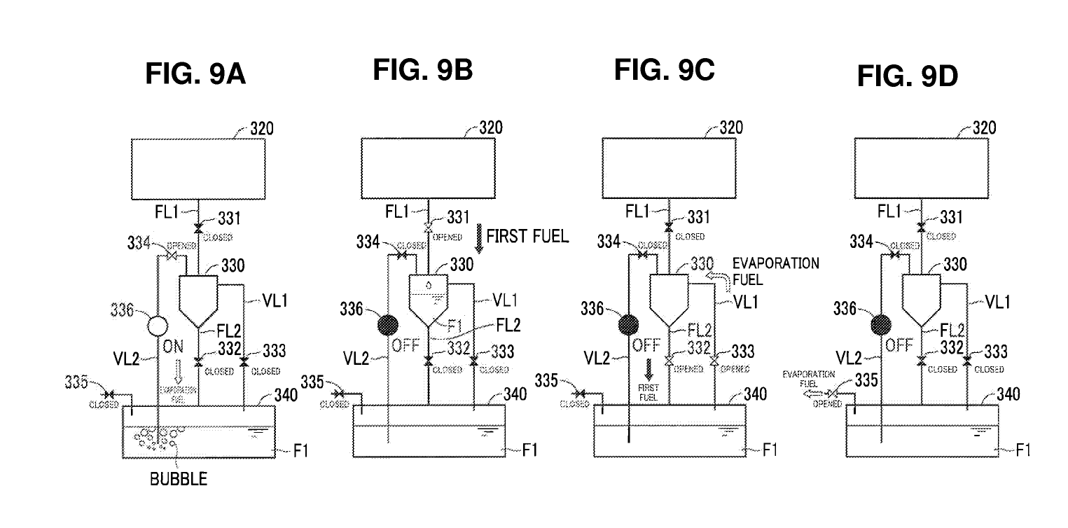

As is shown in FIG. 9A, the condenser 330 is depressurized by the operation of the vacuum pump 336 in a first state in which the fourth opening-closing mechanism 334 is opened while the first opening-closing mechanism 331, the second opening-closing mechanism 332, and the third opening-closing mechanism 333 are closed.

In the first state, in a case where the internal atmospheric pressure P of the condenser 330 has reached to be equal to or less than a first negative pressure P₁, the first opening-closing mechanism 331 is opened and the operation of the vacuum pump 336 is stopped. By this, a second state is realized in which the first opening-closing mechanism 331 is opened while the second opening-closing mechanism 332, the third opening-closing mechanism 333, and the fourth opening-closing mechanism 334 are closed as shown in FIG. 9B.

In the second state, the separation of the first fuel F₁ and the second fuel F₂ by the separator 320 is started, and the first fuel F₁ in a gas phase state is supplied to the condenser 330 from the separator 320 (refer to the black arrow of FIG. 9B). At least a part of the first fuel F₁ in the gas phase state is condensed (being phase transit from a gas phase to a liquid phase) in the condenser 330 which is in a negative pressure and a coolant state, and then retained. Moreover, the evaporation fuel V is increased in the condenser 330 by stopping the vacuum pump 336, and the internal atmospheric pressure of the condenser 330 is raised.

In a case where the internal atmospheric pressure P of the condenser 330 has reached to be equal to or higher than a second negative pressure P₂ which is higher than the first negative pressure P₁, the first opening-closing mechanism 331 is closed while the second opening-closing mechanism 332 and the third opening-closing mechanism 333 are opened. By this, a third state is realized in which the first opening-closing mechanism 331 and the fourth opening-closing mechanism 334 are closed while the second opening-closing mechanism 332 and the third opening-closing mechanism 333 are opened as shown in FIG. 9C.

By opening the third opening-closing mechanism 333, the evaporation fuel V is supplied to the condenser 330 from the first fuel tank 340, and the pressure of the condenser 330 is raised and equals to the pressure of the first fuel tank 340 (refer to the white arrow of FIG. 9C). By closing the first opening-closing mechanism 331, the separation of the first fuel F₁ and the second fuel F₂ by the separator 320 is stopped. By opening the second opening-closing mechanism 332, the first fuel F₁ retained in the condenser 330 is supplied to the first fuel tank 340 (refer to the black arrow of FIG. 9C).

In a case a designated time (for example, 10 [s]) has elapsed after the third state is realized, both of the second opening-closing mechanism 332 and the third opening-closing mechanism 333 are closed while the fourth opening-closing mechanism 334 is opened and the first state is realized and the operation of the vacuum pump 336 is started (refer to FIG. 9A).

In the first state, the evaporation fuel V (gas) is supplied to the first fuel tank 340 from the condenser 330 (refer to the white arrow in FIG. 9A), and the internal atmospheric pressure P of the condenser 330 decreases. The evaporation fuel V induces bubbling of the first fuel F₁ in the first fuel tank 340, and at least a part of the evaporation fuel V in the bubbles can be taken into the first fuel F₁ which is in the liquid phase state. In the first fuel tank 340, the first fuel F₁ is in a two phase state (gas phase-liquid phase), and by supplying the evaporation fuel V from the condenser 330, the pressure of the first fuel tank 340 is raised. The evaporation fuel V may be also supplied to a space which is filled with the evaporation fuel V in the first fuel tank 340 from the condenser 330.

Moreover, the controller 4 determines whether or not an opening condition of the first fuel tank 340 is satisfied during the execution of the negative pressure control processing. As the opening condition, a condition that the measured atmospheric pressure of the first fuel tank 340 has become equal to or higher than a threshold value, or a condition that an acceleration request of the vehicle exceeding a threshold value was made, or a combination of these conditions may be adopted. Then, in a case where it is determined that the opening condition is satisfied, a fourth state is realized in which the fifth opening-closing mechanism 335 is opened as shown in FIG. 9D. On such occasion, for example, the first opening-closing mechanism 331, the second opening-closing mechanism 332, the third opening-closing mechanism 333, and the fourth opening-closing mechanism 334 are closed. In the fourth state, the evaporation fuel V is emitted from the first fuel tank 340, and then supplied to the internal combustion engine 2 through the intake pipe 21.

### Configuration of a Fuel Supply System (Second Embodiment)

The fuel supply system 3 in a second embodiment of the present invention as shown in FIG. 10, has the same features as the fuel supply system 3 in the first embodiment of the present invention shown in FIG. 8. Therefore, the common features are indicated by the same reference numerals and the explanation thereof is abbreviated.

A third opening-closing mechanism 333 is provided in a path connecting a condenser 330 and an outside air atmosphere (whether inside or outside the vehicle). By opening the third opening-closing mechanism 333, it is configured to introduce outside air into the condenser 330. Here, it may be configured that the third opening-closing mechanism 333 is provided in a path connecting the condenser 330 and a canister 350 which is the air source, and an evaporation fuel V adsorbed to the canister 350 is introduced into the condenser 330 by opening the third opening-closing mechanism 333.

Moreover, a vacuum pump 336 is provided in a path connecting a first fuel tank 340 and the canister 350. This path is connected to a path connecting the canister 350 and a low pressure chamber 324 of a separator 320. The fourth opening-closing mechanism 334 and the fifth opening-closing mechanism 335 shown in FIG. 8 are abbreviated.

### Negative Pressure Control Processing (Second Embodiment)

The condenser 330 is decompressed by the operation of the vacuum pump 336 in a first state, in which the first opening-closing mechanism 331, the second opening-closing mechanism 332, and the third opening-closing mechanism 333 are closed.

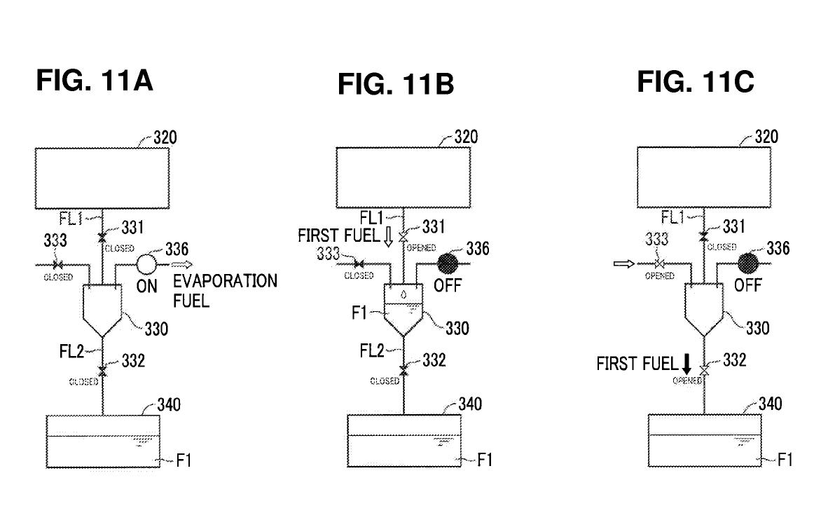

In the first state, in a cases where the internal atmospheric pressure P of the condenser 330 has reached to be equal to or less than a first negative pressure Pi, the operation of the vacuum pump 336 is stopped and also the first opening-closing mechanism 331 is opened as shown in FIG. 11B. By this, a second state is realized in which the first opening-closing mechanism 331 is opened, while the second opening-closing mechanism 332 and the third opening-closing mechanism 333 are closed.

In the second state, the separation of the first fuel F₁ and the second fuel F₂ is started by the separator 320, and the first fuel F₁ in a gas phase state is supplied to the condenser 330 from the separator 320 (refer to the white arrow in FIG. 11B). At least a part of the first fuel F₁ in the gas phase state is condensed (being phase transit from the gas phase to the liquid phase) in the condenser 330 which is in a negative pressure and a coolant state, and then retained. Moreover, by stopping the vacuum pump 336, the evaporation fuel V is increased in the condenser 330 and the internal atmospheric pressure of the condenser 330 is raised.

In a case where the internal atmospheric pressure P of the condenser 330 has reached to be equal to or higher than a second negative pressure P₂ which is higher than the first negative pressure P₁, the first opening-closing mechanism 331 is closed, while the second opening-closing mechanism 332 and the third opening-closing mechanism 333 are opened as shown in FIG. 11C. By this a third state is realized in which the first opening-closing mechanism 331 is closed while the second opening-closing mechanism 332 and the third opening-closing mechanism 333 are opened.

In a case where a designated time (for example, 10 [s]) has elapsed since the third state is realized, by closing both of the second opening-closing mechanism 332 and the third opening-closing mechanism 333, the first state is realized again and the operation of the vacuum pump 336 is started (refer to FIG. 11A).

1. A fuel supply system mounted in a vehicle and configured to supply a first fuel which is separated from a raw fuel and containing more high-octane number component than the raw fuel, and the raw fuel or a second fuel which is separated from the raw fuel and containing more low-octane number component than the raw fuel, selectively or by a specified mixing ratio to an internal combustion engine simultaneously, comprising:
a separator which is sectioned to a high pressure chamber and a low pressure chamber via a separation membrane, and configured to separate the raw fuel into the first fuel and the second fuel by the separation membrane in a state the low pressure chamber is maintained in a lower pressure than the high pressure chamber, and then to collect the first fuel from the low pressure chamber side and to collect the second fuel from the high pressure chamber side;
a condenser which is connected to the low pressure chamber of the separator;
a first fuel tank connected to the condenser and configured to store the first fuel; and
a vacuum pump configured to depress an inner portion of the condenser;
wherein the separator and the first fuel tank are accumulated and are configured to be arranged in an air path of the vehicle so that a part of or a total of the separator is hidden by the first fuel tank with respect to an upper stream side of the air path.

2. The fuel supply system according to claim 1, wherein the separator, the vacuum pump, and the first fuel tank are accumulated and are configured to be arranged in the air path so that a part of or a total of the vacuum pump is hidden by the first fuel tank with respect to the upper stream side of the air path.

3. The fuel supply system according to claim 2, wherein the vacuum pump is configured to be arranged at a side of the separator.

4. The fuel supply system according to claim 1, wherein the separator, the condenser, and the first fuel tank are accumulated and are configured to be arranged in the air path so that a part of or a total of the condenser is exposed with respect to the upper stream side of the air path.

5. The fuel supply system according to claim 4, wherein the condenser is configured to be arranged at a side of the separator.

6. The fuel supply system according to claim 1, further comprising a cooler configured to cool the second fuel collected from the separator,
wherein the separator, the cooler, and the first fuel tank are accumulated and are configured to be arranged in the air path so that a part of or a total of the cooler is exposed with respect to the upper stream side of the air path.

7. The fuel supply system according to claim 1, further comprising a canister configured to occlude high-octane number component occurred from the first fuel or the raw fuel,
wherein the separator, the canister, and the first fuel tank are accumulated and are configured to be arranged in the air path so that a part of or a total of the canister is hidden by the first fuel tank with respect to the upper stream side of the air path.

8. The fuel supply system according to claim 7, wherein the canister is configured to be arranged at a side of the separator.

9. The fuel supply system according to claim 1, further comprising a raw fuel tank configured to store the raw fuel,
wherein the raw fuel tank, among component parts of the fuel supply system, is configured to be arranged in a lower space of a front floor panel of the vehicle, and a part of or all of other component parts are configured to be arranged being accumulated on a rear floor panel.

10. The fuel supply system according to claim 9, wherein at least one component part excluding the raw fuel tank among the component parts of the fuel supply system is configured to be at least partially accommodated in a lower level portion which is formed in the rear floor panel and locally downwardly lowered or hollowed.

11. The fuel supply system according to claim 10, wherein, the first fuel tank, as the at least one component part, is configured to be at least partially accommodated in the lower level portion.

12. The fuel supply system according to claim 9, wherein the raw fuel tank is configured to be at least partially accommodated in a floor tunnel.

13. A vehicle comprising:
an internal combustion engine;
a raw fuel tank configured to store raw fuel; and
a fuel supply system configured to supply a first fuel which is separated from the raw fuel and containing more high-octane number component than the raw fuel, and the raw fuel or a second fuel which is separated from the raw fuel and containing more low-octane number component than the raw fuel, selectively or by a specified mixing ratio to the internal combustion engine simultaneously;
wherein the fuel supply system comprises,
a separator which is sectioned to a high pressure chamber and a low pressure chamber via a separation membrane, and configured to separate the raw fuel into the first fuel and the second fuel by the separation membrane in a state the low pressure chamber is maintained in a lower pressure than the high pressure chamber, and then to collect the first fuel from the low pressure chamber side, and to collect the second fuel from the high pressure chamber side,
a condenser which is connected to the low pressure chamber of the separator,
a first fuel tank connected to the condenser and configured to store the first fuel, and
a vacuum pump configured to decompress an inner side of the condenser,
wherein the separator and the first fuel tank are accumulated and are configured to be arranged in an air path of the vehicle so that a part of or a total of the separator is hidden by the first fuel tank with respect to an upper stream side of the air path.

14. The vehicle according to claim 13, wherein the separator, the vacuum pump, and the first fuel tank are accumulated and arranged in the air path so that a part of or a total of the vacuum pump is hidden by the first fuel tank with respect to the upper stream side of the air path.

15. The vehicle according to claim 14, wherein the vacuum pump is arranged at a side of the separator.

16. The vehicle according to claim 13, wherein the separator, the condenser, and the first fuel tank are accumulated and arranged in the air path so that a part of or a total of the condenser is exposed with respect to the upper stream side of the air path.

17. The vehicle according to claim 16, wherein the condenser is arranged at a side of the separator.

18. The vehicle according to claim 13, further comprising a cooler configured to cool the second fuel collected from the separator,
wherein the separator, the cooler, and the first fuel tank are accumulated and arranged in the air path so that a part of or a total of the cooler is exposed with respect to the upper stream side of the air path.

19. The vehicle according to claim 13, further comprising a canister configured to occlude high-octane number component occurred from the first fuel or the raw fuel,
wherein the separator, the canister, and the first fuel tank are accumulated and arranged in the air path so that a part of or a total of the canister is hidden by the first fuel tank with respect to the upper stream side of the air path.

20. The vehicle according to claim 19, wherein the canister is arranged at a side of the separator.

21. The vehicle according to claim 13, wherein the raw fuel tank, among component parts of the fuel supply system, is arranged in a lower space of a front floor panel, and a part of or all of other component parts are arranged being accumulated on a rear floor panel.

22. The vehicle according to claim 21, wherein a lower level portion which is locally downwardly lowered or hollowed is formed in the rear floor panel, and at least one component part excluding the raw fuel tank among the component parts of the fuel supply system is arranged so as to be at least partially accommodated in the lower level portion.

23. The vehicle according to claim 22, wherein, the first fuel tank for storing the first fuel, as the at least one component part, is arranged so as to be at least partially accommodated in the lower level portion.

24. The vehicle according to claim 21, wherein the raw fuel tank is arranged so as to be at least partially accommodated in a floor tunnel.
